(19) United States
(12) Patent Application Publication
(10) Pub. No.: US 2026/0288966 A1
(43) Pub. Date: Sep. 24, 2026

(54) VERIFICATION METHOD FOR A FAST SECURE BOOT

(71) Applicant: Steering Solutions IP Holding Corporation, Saginaw, MI (US)

(72) Inventors: Harvey XIA, Suzhou (CN); Yuki ZHU, Suzhou (CN); Amiya WANG, Suzhou (CN); Skylar YU, Suzhou (CN)

(21) Appl. No.: 19/093,693

(22) Filed: Mar. 28, 2025

(30) Foreign Application Priority Data
Mar. 24, 2025 (CN) 2025103536979

(51) Int. Cl. G06F 21/57; H04L 9/32

(52) U.S. Cl. CPC G06F 21/575; H04L 9/3242; G06F 2221/034

(57) ABSTRACT

A method for performing a partial memory check during a secure boot process includes defining N different areas of a memory, where N is an integer greater than one, generating a verification sequence for the N different areas of the memory, performing the partial memory check for a first selected area of the N different memory areas in accordance with the verification sequence; and completing the secure boot process without performing the partial memory check for remaining unselected areas of the N different memory areas.

### CROSS-REFERENCE TO RELATED APPLICATIONS

This application claims the benefit of Chinese Application No. 2025103536979, filed on Mar. 24, 2005. The entire disclosure of the application referenced above is incorporated herein by reference

### TECHNICAL FIELD

This disclosure relates to software verification techniques for electronic power steering (EPS) systems.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY OF THE INVENTION

This disclosure relates generally to software verification techniques for electronic power steering (EPS) systems.

An aspect of the disclosed embodiments includes a method for performing a partial memory check during a secure boot process includes defining N different areas of a memory, where N is an integer greater than one, generating a verification sequence for the N different areas of the memory, performing the partial memory check for a first selected area of the N different memory areas in accordance with the verification sequence; and completing the secure boot process without performing the partial memory check for remaining unselected areas of the N different memory areas.

In another aspect, a system is configured to perform one or more functions of the various methods described herein. In another aspect, a processor is configured to execute instructions stored in memory to perform one or more functions of the various methods described herein.

Further areas of applicability of the present disclosure will become apparent from the detailed description, the claims and the drawings. The detailed description and specific examples are intended for purposes of illustration only and are not intended to limit the scope of the disclosure.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates an example domain controller and electronic control unit (ECU) according to the principles of the present disclosure.

FIG. 2 shows an example implementation of partial memory check techniques according to the principles of the present disclosure.

FIG. 3 is a flow diagram generally illustrating example steps of a method for performing partial memory check techniques according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like. Although described herein with respect to vehicles, the principles of the present disclosure may also be implemented in other types of transportation or non-transportation apparatuses including steering systems.

A steering system may include various controller architectures to control various actuators for engaging and/or actuating components of the steering system. In some examples, steering system may include one or more domain controllers configured to control functions of a specific area or domain of the vehicle. For example, a steering domain controller may be configured to control functions of the steering system, including controlling the various actuators. In some examples, the vehicle may include various electronic control units (ECUs) or other controllers. As used herein, “ECU” may refer to a hardware module or assembly including one or more processors or microcontrollers, memory, sensors, one or more actuators, a communication interface, etc., any portions of which may be collectively referred to as “circuitry.” In examples that implement domain controller architecture, various ECUs may be responsive to one or more domain controllers.

Various techniques may be used to protect vehicle controllers, software, and systems from intrusion (e.g., intrusion from security threats, such as hackers or other attackers). As one example, a secure boot process may be executed at vehicle startup. The secure boot process may include a full or partial memory check to verify contents of memory associated with operation of system software that is executed using various controllers (e.g., contents of flash or other non-volatile memory).

Vehicle manufacturers may require that the secure boot process is completed within a short timeframe (e.g., 200 ms or less). However, a full memory check (e.g., a verification of all memory locations) may exceed a required timeframe. Accordingly, in some examples, a partial memory check (e.g., verification of only a fixed flash area or range of locations) may be performed to reduce the duration of the secure boot process (“secure boot startup time”). However, partial memory checks may fail to detect whether content has been modified (e.g., tampered with by an attacker) in one or more memory locations.

Verification systems and methods according to the present disclosure are configured to implement partial memory check techniques during the secure boot process that maximize verification of memory locations while reducing the secure boot startup time.

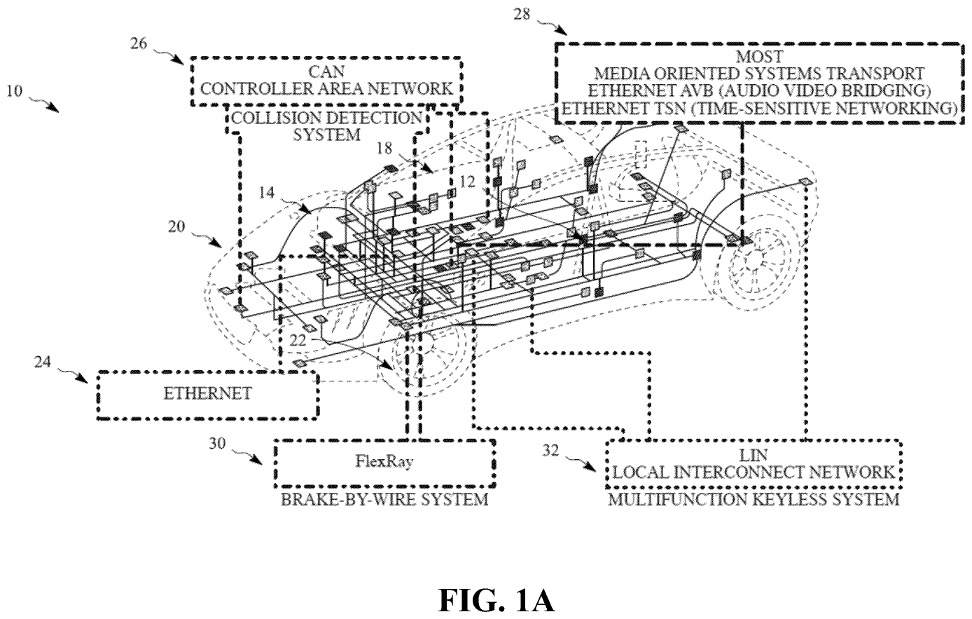

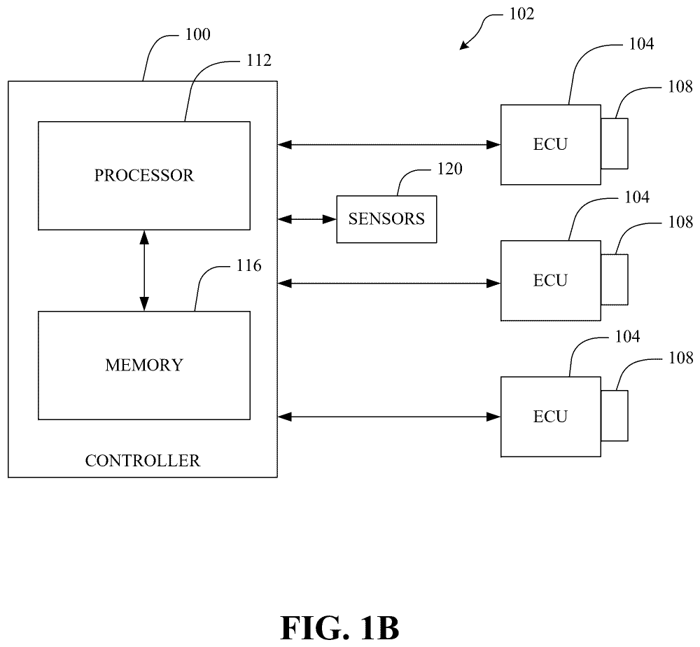

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include an electric, hybrid or a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10. The steering system of the present disclosure is configured to implement handwheel estimation systems and methods as described below in more detail.

The vehicle 10 includes one or more controllers, such as a controller 100, as is generally illustrated in FIG. 1B. The controller 100 may correspond to a steering system controller. The controller 100 may include or be implemented as any suitable controller, such as an electronic control unit or other suitable controller or control circuitry. In some examples, the controller 100 may correspond to a domain controller of a domain 102 (e.g., a steering system domain) including a plurality of ECUs 104. For example, the controller 100 and ECUs 104 may correspond to controllers and actuators of a steering system of the vehicle 10. Each of the ECUs 104 may include and/or be associated with a respective actuator 108 or other control mechanism configured to actuate, control, provide torque to, etc. a component of the steering system.

The controller 100 and ECUs 104 may be configured to control, for example, the various functions of the steering system and/or various functions of the vehicle 10. The ECUs 104 may have a same or different configuration as the controller 100 as described below. For example, the controller 100 may include a processor 112 and a memory 116. The processor 112 may include any suitable processor, such as those described herein. Additionally, or alternatively, the controller 100 may include any suitable number of processors, in addition to or other than the processor 112.

The memory 116 may comprise a single disk or a plurality of disks (e.g., hard drives), and includes a storage management module that manages one or more partitions within the memory 116. In some embodiments, the memory 116 may include flash memory, semiconductor (solid state) memory or the like. The memory 116 may include Random Access Memory (RAM), a Read-Only Memory (ROM), or a combination thereof. The memory 116 may include instructions that, when executed by the processor 112, cause the processor 112 to, at least, control various aspects of the vehicle 10. Additionally or alternatively, the memory 116 may include instructions that, when executed by the processor 112, cause the processor 112 to perform functions associated with the systems and methods described herein.

The controller 100 may receive one or more signals from various measurement devices or sensors 120 indicating sensed or measured characteristics of the vehicle 10. The sensors 120 may include any suitable sensors, measurement devices, and/or other suitable mechanisms. For example, the sensors 120 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof. As used herein, “sensors” may correspond to physical sensors or derived signals (e.g., signals derived from algorithms or calculations based on one or more sensor inputs both directly into the controller or using data communicated to the controller from sources outside the immediate controller area).

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B. In some examples, one or more functions may be performed remotely (e.g., relative to the vehicle), such as at a controller, processor, circuitry, etc. of a remote server, cloud computing system, and/or other remote processing system.

One or more of the controller 100, the ECU 104, and/or other controllers of the vehicle 10 may be configured to implement verification systems and methods (including partial memory check techniques) of the present disclosure. For example, one or more processors, such as the processor 112, are configured to perform partial memory check techniques (e.g. on memory locations of non-volatile memory, such as the memory 116) during the secure boot process as described below in more detail.

Partial memory check techniques according to the present disclosure may be described with respect to one or more processors (e.g., the processor 112) and memory (e.g., the memory 116). For example, the memory 116 may correspond to flash memory storing software executed by the processor 112 and/or other components of the vehicle 10. In an example, the processor 112 is configured to execute instructions stored in the memory 116 and/or other memory to perform a secure boot process upon startup of the vehicle 10. The processor 112 may correspond to a controller or other processing device of an EPS system.

In examples where a full memory check is performed during a secure boot process, a full memory check is performed on the memory 116 to verify all memory locations of the memory 116. Verification of memory locations may include, but is not limited to, verifying that software components are stored in respective correct memory locations (e.g., desired memory regions) within the memory 116, verifying that one or more memory regions are properly protected, and/or verifying that no corruption of memory locations or regions has occurred (e.g., due to corruption, tampering, etc.).

In examples where a partial memory check is performed, only a fixed flash area or range of locations of the memory 116 are verified. For example, the same predetermined flash area or range of locations of the memory 116 may be verified during each secure boot process.

Conversely, partial memory check techniques according to the present disclosure are configured to perform a partial memory check on a different portion (i.e., a different flash area or range of locations) of the memory 116 at each startup. For example, the memory 116 may be divided into N separate flash areas or ranges of locations (where N is an integer greater than one). At each startup, the partial memory check is performed on a different one of the N areas in a predesigned sequence. Accordingly, after N startups and corresponding secure boot processes, each of the N flash areas will be verified. The N flash areas can be verified in a same (e.g., predetermined) or different (e.g., randomized) sequence in respective startups.

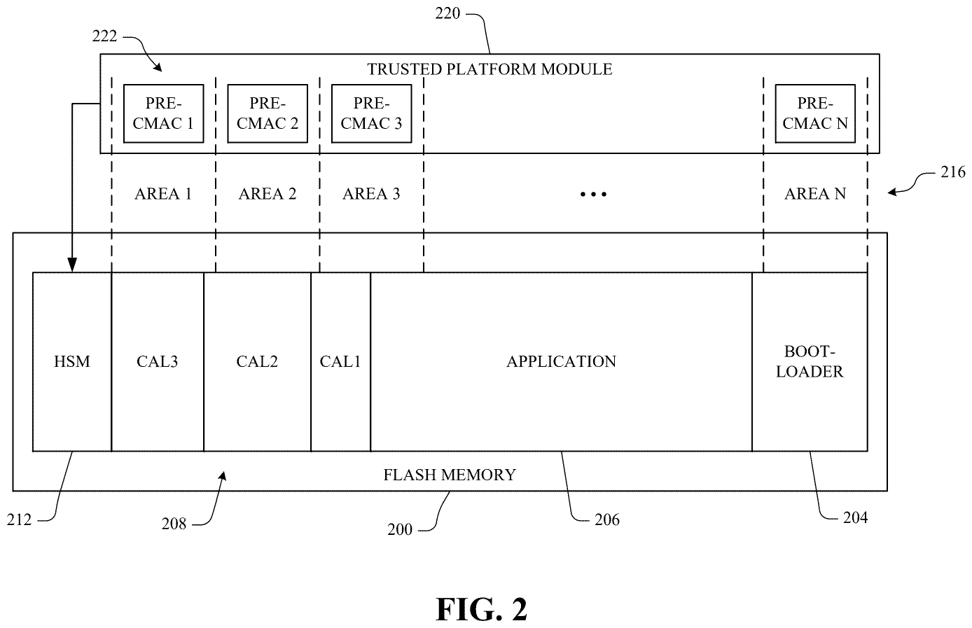

FIG. 2 shows an example implementation of the partial memory check techniques of the present disclosure performed on memory, such as flash memory 200. For example, the flash memory 200 may correspond to or be a component of the memory 116. The flash memory 200 may store, in respective memory regions, various software and/or data components, including, but not limited to, a bootloader 204, application data 206 (e.g., one or more applications or application software), and calibration data (e.g., CAL1, CAL2, CAL3, etc.) 208. In an example, the bootloader 204 executes upon startup of a system including the memory 200 (e.g., upon startup of a vehicle, EPS system, etc.) and is configured to initialize hardware components (e.g., the processor 112, the memory 116, etc.). The bootloader 204 may be configured to load an operating system and/or perform one or more other startup tasks.

In some examples, the flash memory 200 may include a hardware security module (HSM) 212. Although shown within the flash memory 200, the HSM 212 may be located external to the flash memory 200. The HSM 212 is configured to perform verifications processes/functions (e.g., functions of the secure boot process), and to store and manage keys (e.g., cryptographic keys) used to perform various verification functions, such as keys used for digital signatures, encryption, and/or other security mechanisms associated with performing secure boot processes. As one example, the HSM 212 stores cipher-based message authentication codes (CMACs) generated for respective areas of the flash memory 200. As used herein, the terms “authentication data” may generally refer to cryptographic keys, authentication codes (e.g., CMACs), and so on.

For example, a unique CMAC can be generated for each software component (e.g., the bootloader 204, the application 206, etc.) using a cryptographic key and respective contents of each software component and stored in a secure memory location (e.g. within the HSM 212). As one example, the CMACs can be initially calculated when data, software, firmware, etc. is first stored/downloaded to the memory 200 (e.g., when the memory 200 is initially flashed). CMACs generated upon initial flashing of the memory 200 may be referred to as “pre-CMACs.”

During a subsequent secure boot process, respective CMACs can be recalculated for each software component and compared to corresponding stored pre-CMACs. If the recalculated CMAC for a particular software component matches the corresponding pre-CMAC for that software component, the software component is considered to be verified or authenticated (e.g., it is determined that the software component has not been tampered with, modified, or otherwise corrupted since the initial flashing of the memory 200). Conversely, if the recalculated CMAC does not match the corresponding pre-CMAC, the software component may be identified as corrupted and the secure boot process can be stopped. In some examples, the memory 200 can then be re-flashed to a previous state.

Partial memory check techniques according to the present disclosure are configured to perform a partial memory check on a different portion or area of the flash memory 200 at each startup. For example, the memory 200 may be divided into N separate flash areas or ranges of locations (e.g., by defining N different memory areas or ranges of locations, where N is an integer greater than one). As one example, a 2 MB flash memory may be divided into 16 area. As shown, the memory 200 is divided into area 1, area 2, area 3, . . . , and area N, which may be referred to collectively as areas 216. The areas 216 may be same or different sizes (e.g., include a same or different number of memory locations). As shown, the areas 216 are not necessarily aligned with components of the flash memory 200. In other words, each of the areas 216 may include portions or locations of different components stored in the memory 200, and each of the components may include portions corresponding to two or more of the areas 216. As one example, corresponding locations (e.g., memory/address/location ranges) of each of the areas 216 may be defined and stored in the HSM 212 or another secure location (e.g., memory external to the memory 200).

As one example, subsequent to the initial flashing of the memory 200, a trust anchor (e.g., a trusted platform module 220, a processor, etc.) calculates respective pre-CMACs (pre-CMAC 2, pre-CMAC 3, pre-CMAC 3, . . . , and pre-CMAC N) 222 for each of the areas 216. The pre-CMACs 222 may be stored in the HSM 212.

In a secure boot process at each subsequent startup, the partial memory check is performed on a different one of the areas 216. For example, the trusted platform module 220 recalculates the CMAC for a selected one of the areas 216 and the recalculated CMAC is compared to the corresponding pre-CMAC. Accordingly, after N startups and corresponding secure boot processes, each of the areas 216 is verified.

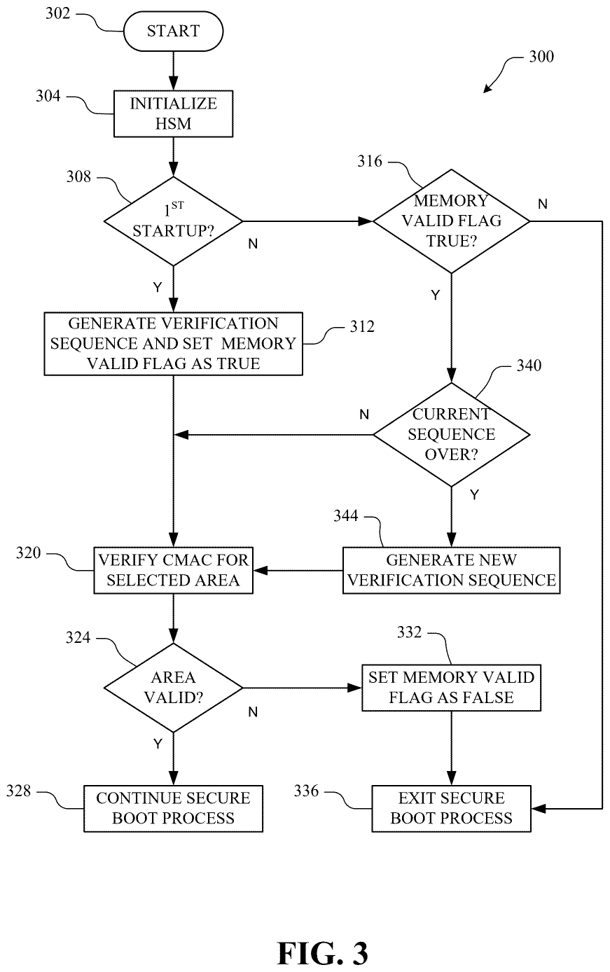

FIG. 3 is a flow diagram generally illustrating a method 300 for performing partial memory check techniques according to the principles of the present disclosure. For example, one or more computing devices, processors, or processing devices, etc. are configured to execute instructions to implement the method 300, such as one or more of the processors of the systems described herein (e.g., a computing device or processor of a vehicle configured to implement the controller 100, the processor 112 and the memory 116, the memory 200, etc.). One or more of the steps of the method 300 as described below may be skipped or omitted in some examples, and/or one or more of the steps may be performed in a different sequence than described.

The method 300 starts at 302. For example, the method 300 corresponds to a secure boot process that is initiated upon startup (e.g., power up) of a vehicle and associated systems, such as an EPS system. In this example, the memory is downloaded/flashed (e.g., with software/firmware) prior to the start of the method 300. For example, the memory have been divided into N areas and pre-CMAC values calculated and stored for each of the N areas as described above.

At 304, the method 304 includes initializing the HSM (e.g., the HSM 212), and may include initializing the bootloader 204. The HSM 212 and/or the bootloader 204 can be used to perform initial steps of the secure boot process.

At 308, the method 300 includes determining whether the current startup is a first startup since the memory was downloaded/flashed (e.g., since the memory was last flashed/updated with verified software or firmware). If true, the method 300 continues to 312. If false, the method 300 continues to 316.

At 312, the method 300 includes generating a check or verification sequence and storing an indication that the memory is valid or verified (e.g., by setting a “memory valid” flag as true). For example, the memory valid flag may be set in a secure location, such as the HSM. The verification sequence indicates a sequence in which the N areas of the memory will be verified in respective secure boot processes, beginning with the current startup. In an example, the verification sequence is randomized, but other sequence generation techniques may be used. The verification sequence may be stored in a secure location (e.g., in the HSM).

At 320, the method 300 includes verifying the CMAC for a selected area. For example, the selected area corresponds to an area selected from among the N areas in accordance with the current verification sequence. For a first startup, the selected area corresponds to the first area in the verification sequence. For subsequent startups, the selected area corresponds to a next area in the verification sequence subsequent to an area verified in an immediately preceding startup. Date indicating a current position or area in the sequence (including indications of previously checked areas, unchecked areas, etc.) may be stored in a secure location (e.g., in the HSM). For example, for N areas, an indicator of a position from 1 to N in the verification sequence may be stored and may be incremented subsequent to completion of each secure boot process. Verifying the CMAC for the selected area may include recalculating the CMAC for the selected area and comparing the recalculated CMAC to the corresponding pre-CMAC as described above.

At 324, the method 300 includes determining whether the selected memory area is valid (i.e., based on results of the CMAC verification performed at 320). If true, the method 300 continues with the secure boot process at 328. If false, the method 300 continues to 332. At 332, the method 300 includes setting the memory valid flag as false. The method 300 then proceeds to 336 to exit the secure boot process.

At 316, the method 300 includes determining whether the memory valid flag is set as true. If true, the method 300 continues to 340. If false, the method 300 exits the secure boot process at 336. In this manner, the method 300 stops the secure boot process if the memory was previously determined to be invalid (e.g., during a previous secure boot process) and the memory was not re-flashed.

At 340, the method 300 includes determining whether a current verification sequence is over/completed (e.g., each of the N areas in a previously generated verification sequence has been verified in respective secure boot processes). If true, the method 300 continues to 344. If false, the method 300 continues to 320 in accordance with the current verification sequence. At 344, the method 300 includes generating a new verification sequence, and then proceeds to 320 in accordance with the new verification sequence.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such. As used herein, the term “approximately” may correspond to within “+/−5.0% of.”

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for performing a partial memory check during a secure boot process, the method comprising:
defining N different areas of a memory, where N is an integer greater than one;
generating a verification sequence for the N different areas of the memory;
performing the partial memory check for a first selected area of the N different memory areas in accordance with the verification sequence; and
completing the secure boot process without performing the partial memory check for remaining unselected areas of the N different memory areas.

2. The method of claim 1, further comprising, prior to the secure boot process, calculating respective authentication codes for the N different areas of the memory and storing the respective authentication codes as pre-authentication codes, wherein performing the partial memory check includes recalculating an authentication code for the first selected area and comparing the recalculated authentication code to the pre-authentication code for the first selected area.

3. The method of claim 2, wherein the respective authentication codes are cipher-based message authentication codes.

4. The method of claim 2, wherein storing the respective authentication codes includes storing the respective authentication codes in a hardware security module.

5. The method of claim 2, wherein performing the partial memory check for the first selected area includes:
determining whether the recalculated authentication code matches the pre-authentication code;
in response to a determination that the recalculated authentication code matches the pre-authentication code, completing the secure boot process without performing the partial memory check for remaining unselected areas of the N different memory areas; and
in response to a determination that the recalculated authentication code does not match the pre-authentication code, exiting the secure boot process without completing the secure boot process.

6. The method of claim 5, further comprising, in response to the determination that the recalculated authentication code matches the pre-authentication code, storing an indication that the memory is valid.

7. The method of claim 5, further comprising, in response to the determination that the recalculated authentication code does not match the pre-authentication code, storing an indication that the memory is not valid.

8. The method of claim 1, further comprising, subsequent to completing the secure boot process, performing a second partial memory check during a second secure boot process, wherein performing the second partial memory check comprises:
performing the second partial memory check for a second selected area of the N different memory areas in accordance with the verification sequence; and
completing the second secure boot process without performing the second partial memory check for the first selected area and the remaining unselected areas of the N different memory areas.

9. The method of claim 1, further comprising determining whether a respective partial memory check was performed for each of the N areas of the memory in accordance with the verification sequence and, in response to a determination that the respective memory check was performed for each of the N areas of the memory in according with the verification sequence, generating a second verification sequence for the N areas of the memory.

10. The method of claim 1, wherein the verification sequence is a random sequence.

11. The method of claim 1, wherein the memory is flash memory.

12. The method of claim 11, wherein the flash memory corresponds to flash memory storing data associate with control of a steering system of a vehicle.

13. A system for performing a partial memory check during a secure boot process of a steering system of a vehicle, the system comprising:
a processor configured to execute instructions stored in memory, wherein executing the instructions causes the processor to
define N different areas of a memory, where N is an integer greater than one,
generate a verification sequence for the N different areas of the memory,
perform the partial memory check for a first selected area of the N different memory areas in accordance with the verification sequence, and
complete the secure boot process without performing the partial memory check for remaining unselected areas of the N different memory areas.

14. The system of claim 13, wherein executing the instructions further causes the processor to, prior to the secure boot process, calculate respective authentication codes for the N different areas of the memory and store the respective authentication codes as pre-authentication codes, wherein performing the partial memory check includes recalculating an authentication code for the first selected area and comparing the recalculated authentication code to the pre-authentication code for the first selected area.

15. The system of claim 14, wherein the respective authentication codes are cipher-based message authentication codes.

16. The system of claim 14, wherein storing the respective authentication codes includes storing the respective authentication codes in a hardware security module.

17. The system of claim 14, wherein performing the partial memory check for the first selected area includes:
determining whether the recalculated authentication code matches the pre-authentication code;
in response to a determination that the recalculated authentication code matches the pre-authentication code, completing the secure boot process without performing the partial memory check for remaining unselected areas of the N different memory areas; and
in response to a determination that the recalculated authentication code does not match the pre-authentication code, exiting the secure boot process without completing the secure boot process.

18. The system of claim 17, wherein executing the instructions further causes the processor to:
in response to the determination that the recalculated authentication code matches the pre-authentication code, store an indication that the memory is valid; and
in response to the determination that the recalculated authentication code does not match the pre-authentication code, store an indication that the memory is not valid.

19. The system of claim 13, wherein executing the instructions further causes the processor to, subsequent to completing the secure boot process, perform a second partial memory check during a second secure boot process, wherein performing the second partial memory check comprises:
performing the second partial memory check for a second selected area of the N different memory areas in accordance with the verification sequence; and
completing the second secure boot process without performing the second partial memory check for the first selected area and the remaining unselected areas of the N different memory areas.

20. The system of claim 13, wherein executing the instructions further causes the processor to determine whether a respective partial memory check was performed for each of the N areas of the memory in accordance with the verification sequence and, in response to a determination that the respective memory check was performed for each of the N areas of the memory in according with the verification sequence, generate a second verification sequence for the N areas of the memory.
